(19) United States
(12) Patent Application Publication
(10) Pub. No.: US 2007/0201906 A1
(43) Pub. Date: Aug. 30, 2007

(54) Cartridge

(76) Inventors: Kishio Tamura, Tokyo (JP); Ken Ohmura, Tokyo (JP); Tomomi Oshiba, Tokyo (JP); Sayuri Nakano, Tokyo (JP)

Correspondence Address: CANTOR COLBURN, LLP, 55 GRIFFIN ROAD SOUTH, BLOOMFIELD, CT, 06002, US

(21) Appl. No.: 11/707,452

(22) Filed: Feb. 16, 2007

(30) Foreign Application Priority Data
Feb. 27, 2006 (JP) JP2006-049902

(51) Int. Cl. G03G 15/08

(52) U.S. Cl. 399/262

(57) ABSTRACT

A cartridge detachably mountable to a main body of an image forming apparatus comprising: a storage container for storing an image forming material having a supply section for supplying the image forming material when engaged with a main body of the image forming apparatus; and a packaging container for packaging the storage container, the packaging container can expose the supply section of the storage container through an opening provided on the packaging container, while packaging the storage container, wherein the cartridge is loaded on the main body of the image forming apparatus in such a state that the storage container is packaged by the packaging container.

### CROSS-REFERENCE TO RELATED APPLICATION

The present application is based on Japanese Patent Application No. 2006-49902 filed with Japan Patent Office on Feb. 27, 2006, entire content of which is hereby incorporated by reference.

### BACKGROUND OF THE INVENTION

1. Field of the Invention

The present invention relates to a cartridge capable of supplying an image forming apparatus with toner or ink when the cartridge together with the packaging container is mounted on the image forming apparatus where the cartridge is made up of a storage container for storing a toner or ink, and a packaging container.

2. Description of the Related Art

In an image forming apparatus using electrophotographic process or ink jetting process, a cartridge for storing toner or ink is loaded to permit constant supply of toner or ink, whereby stable image formation is ensured. Such a cartridge structure is found in a cartridge arranged in such a way that toner or ink is accommodated in a soft bag-like container, which is housed in a rigid packaging container.

Japanese Utility-model laid-open publication No. 7-16940, for example, teaches a toner cartridge container made up of a soft bag-like cartridge for storing the toner and a protective carton for storing and protecting this cartridge. And Japanese patent laid-open publication No. 2005-14439 teaches an ink cartridge, made up of an ink bag for containing ink and two covers for covering the ink bag so as to sandwiching it from outside.

To protect the environment and resources, there is a very active effort going on to recover used cartridges in recent years. For the aforementioned cartridge, both the bag-like container with ink or toner and the protective packaging container should be thoroughly recovered by vendors, from an idealistic viewpoint.

Incidentally, when the container of the aforementioned form is loaded onto an image forming apparatus, the container for storing ink or toner is generally taken out of the packaging container called a unitary package box such as a hard and rigid protective carton and cover, and is loaded on the image forming apparatus. The aforementioned two publications do not refer to the cases wherein the container equipped with a unitary package box such as a protective carton and cover is loaded on the image forming apparatus.

As described above, when a container is loaded onto the image forming apparatus in the form removed from the packaging container, it would be necessary to request the users to take care of the packaging container in an effort to get their cooperation in the recovery of used cartridges. For example, it would be necessary to secure a storage space to ensure that the packaging container is not lost. Further, when users are not willing to take part in the cartridge recovery campaign, the packaging container will be treated as a waste. This is not recommended from the viewpoint of environment and resources protection.

As described above, when only the container for accommodating toner or ink is loaded on the image forming apparatus, users are obliged to take some measures to take care of the packaging container. This will impose inconvenience and trouble on users.

### SUMMARY OF THE INVENTION

An object of the present invention is to solve such problems and to provide a cartridge that can be loaded on an image forming. To be more specific, the object of the present invention is to provide a cartridge wherein the cartridge equipped with a packaging container is loaded on an image forming apparatus, whereby the cartridge can be removed from the image forming apparatus after use, without loss of the packaging container or occurrence of waste, and can be recovered with the packaging container.

According to the first aspect of the present invention, there is provided a cartridge detachably mountable to a main body of an image forming apparatus comprising: a storage container for storing an image forming material having a supply section for supplying an image forming material when engaged with the image forming apparatus main body; and a packaging container for packaging the storage container, wherein the storage container has a supply section for supplying an image forming material when engaged with a main body of the image forming apparatus, and the packaging container, while packaging the storage container, the packaging container can expose the supply section of the storage container through the opening, while packaging the storage container, wherein the cartridge is loaded on the main body of the image forming apparatus main body, in such a state that the storage container is packaged by the packaging container.

According to one embodiment of the present invention, a cartridge can be mounted on the image forming apparatus while it is equipped with a packaging container. This eliminates the time and effort for securing a space for temporary storage of the packaging container while the toner or ink are supplied, or for implementing such a management as to ensure that the packaging container is not lost, thereby reducing the user's load.

According to one embodiment of the present invention, a global environment-friendly cartridge is provided because of reduced possibility of losing a packaging container and a reliable recovery of the used cartridge including the packaging container.

According to one embodiment of the present invention, a cartridge of enhanced usability is provided due to elimination of the time and effort for removing the container incorporating the toner or ink from the packaging container when loading the cartridge, or for re-packaging the used and contaminated container into the packaging container.

### BRIEF DESCRIPTION OF THE DRAWINGS

FIG. 1 is a schematic perspective view of a cartridge of the present invention;

FIG. 2 is a schematic perspective view of a storage container 200 for storing toner;

FIG. 3 is a schematic perspective view of another embodiment of the storage container 200 for storing toner;

FIG. 4 is a schematic perspective view of a packaging container 300;

FIG. 5 is a cross sectional view taken along arrow line Z-Z representing the toner supply section in an image forming apparatus of FIG. 8;

FIG. 6 is a schematic perspective exploded view of a cap member 200B;

FIG. 7 are a side view and a partial plan view close to the toner supply section 100 of FIG. 8.

FIG. 8 is a schematic diagram representing a tandem type color image forming apparatus;

FIG. 9 is a schematic diagram representing the internal structure of a development apparatus 4 and the toner supply section;

FIG. 10 is a partial plan view of the end of the development apparatus 4 of FIG. 9;

FIG. 11 is a partial plan view of the development apparatus 4 of FIG. 9; and

FIG. 12 is a side view of the development apparatus 4 of FIG. 9.

### DETAILED DESCRIPTION OF THE PREFERRED EMBODIMENTS

To explain an embodiment of the cartridge of the present invention, the following refers to drawing and describes the embodiment of a cartridge for storing toner used for image formation using electrophotographic process, and the embodiment of an image forming apparatus using the cartridge. The cartridge in the sense in which it is used here can be defined as a container which incorporates an image forming material such as toner and is directly mounted on the image forming apparatus, whereby the image forming material is supplied.

The assertive description of the embodiments refers to that in the best mode, without the terminology or technological scope being restricted thereto.

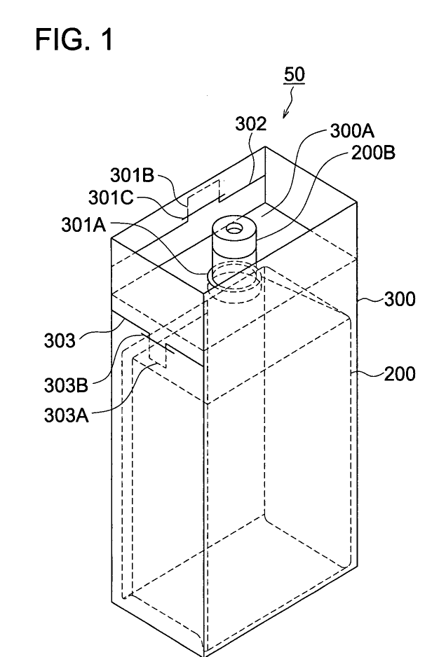

The following will first describes an example of the cartridge of the present invention: The cartridge of FIG. 1 is made up of a toner storage container 200 corresponding to the storage container for storing toner as an image forming material, and a packaging container 300 for packaging the toner storage container 200. The packaging container 300 refers to a packaging box which includes the information used in the phase of distribution from factory shipment to the final user and is used to protect the toner stored in the toner storage container 200 and toner storage container.

The following describes the cartridge 50 of the present invention with reference to FIGS. 1 through 3:

FIG. 1 is a schematic perspective view of a cartridge 50. On the lateral surface forming the packaging container 300, the opening 300A that can be opened or closed is opened to expose the cap member 200B corresponding to the supply section for supplying the image forming apparatus with the toner stored in the toner storage container 200. In the conventional art, there has been no apparatus wherein, when the cartridge 50 is to be mounted on the image forming apparatus, only the toner storage container 200 is loaded on the image forming apparatus, with the packaging container 300 mounted thereon. In the present invention, the toner cartridge 50 is loaded on the image forming apparatus, the storage container 200 being packed in the packaging container 300. This arrangement reduces the time and effort for storing the packaging container 300.

The cartridge 50 of the present invention of FIG. 1 can be equipped with a detection frame fool-proof) and IC chip, although not illustrated.

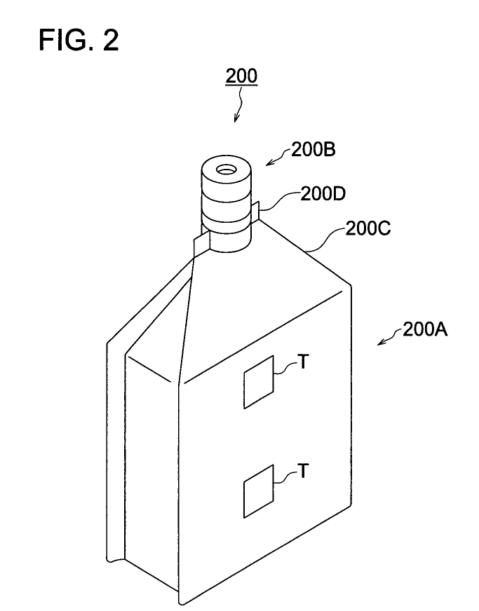

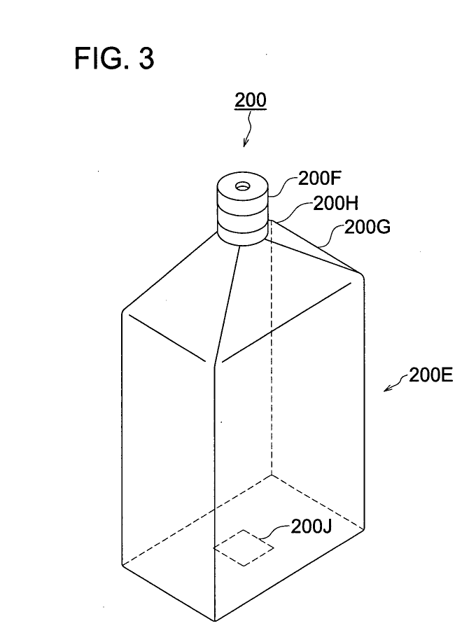

FIG. 2 is a schematic perspective view of a toner storage container 200. FIG. 3 is a schematic perspective view of another embodiment of the toner storage container 200.

As shown in FIG. 2, the toner storage container 200 includes a flexible bag member 200A such as polyethylene or nylon to store toner and a cap member 200B for charging or discharging the toner.

As illustrated, the bag member 200A has a funnel section 200C to ensure smooth discharge of toner. The tip end 200D having a narrow funnel section 200C is sealed and secured by adhesion so as to wrap in the cap member 200B.

The bag member 200A can be manufactured in such a way that a plurality of sheet members constituting each side are close to each other, as disclosed, for example, in the Japanese Non-Examined Patent Application Publication (Tokkai) 2005-309168.

The details of the cap member 200B will be described later.

FIG. 3 represents another embodiment of the storage container 200. It is made up of a toner storage bag member 200E manufactured by blow molding, and a cap member 200F having a function of charging or discharging toner.

As shown in FIG. 3, the bag member 200E has a funnel section 200G, and the tip end 200H having a narrow funnel section 200G is sealed and secured to the cap member 200F by adhesion.

The cap member 200F has the same basic structure as that of the cap member 200B.

A filter member 200J is secured on the bottom surface of the bag member 200E by adhesion. When toner is sucked by a powder pump (to be described later), this filter prevents toner from passing although it allows the passage of air so that excessive negative pressure will not occur inside the bag member 200E.

The storage container made of a flexible bag member eliminates the need of using a buffer material, for example, and provides a compact and simplified cartridge structure. This ensures that a greater number of used cartridges can be mounted on a track when used cartridges are recovered.

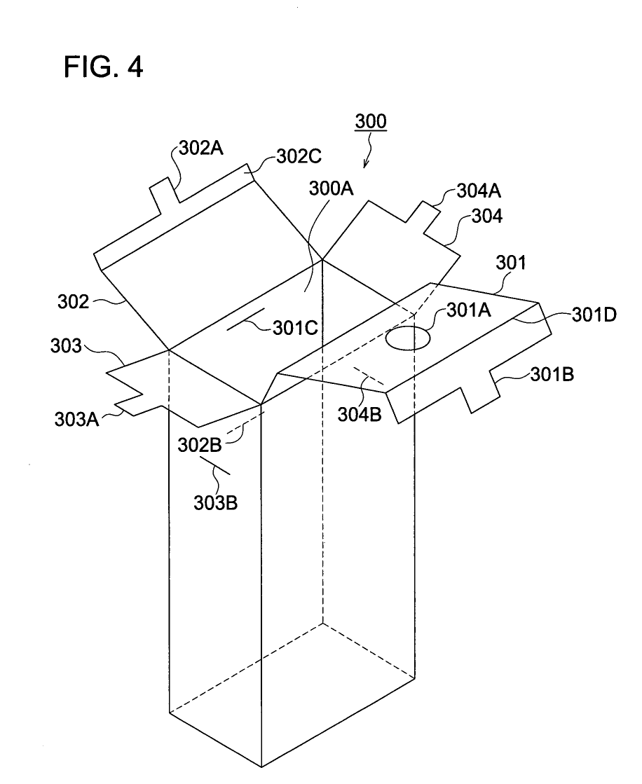

Referring to FIG. 4, the following describes the packaging container 300 for packaging the toner storage container 200. The packaging container 300 can be used for transportation. To be more specific, it has the strength to withstand the impact imposed during the transport, and the weather resistance to ensure that the printing on the container surface will not be affected by rain and others.

Further, the surface of the packaging container 300 can be printed with product names, handling care marks and barcodes used for checkups at the time of distribution. The packaging container 300 can be made of paper such as a corrugated fiberboard and pulp molding material, or resin materials such as expandable polystyrene and polyester resin materials. A double-structured bag made of paper and resin can also be used. Further, a combination of these materials can be used to form this container. The surface of these materials is provided with treatment that allows distribution information to be printed.

The following describes the packaging container 300 of FIG. 4: The packaging container 300 is structured in such a way that, when the toner storage container 200 is mounted, the side facing the cap member 200B of the toner storage container 200 is made up of a front flap 301, rear flap 302, left flap 303 and right flap 304.

The reference numeral 301A denotes a cap holding hole provided approximately at the center of the front flap 301. As illustrated in FIG. 1, the diameter of the cap holding hole 301A is the same as that of the cap member 200B of the toner storage container 200. This cap holding hole is provided to ensure that the cap member 200B does not move when the toner storage container 200 is mounted in position.

The reference numeral 301B indicates a tongue provided on the tip end of the front flap 301. As illustrated in FIG. 1, this tongue is engaged with the slit 301C provided on the packaging container 300 when the toner storage container 200 is mounted in position and the front flap 301 is folded inside.

As described above, if the tongue 301B is engaged with the slit 301C, it cooperates with the cap holding hole 310A to ensure that the toner storage container 200 will not slip out downward, when the cap member 200B of the toner storage container 200 is positioned to face downward to supply toner.

In addition to the method given above, the toner storage container 200 can also be secured onto the packaging container 300 as follows: For example, the bag member 200A of the toner storage container 200 can be secured on the packaging container 300 by a double-faced tape or the like. One surface of the bag member 200A can be secured on the inner surface of the packaging container 300 by a double-faced tape T, for example, as shown in FIG. 2. Thus the storage container is integrated with the packaging container.

If the bag member 200A is secured in position in the aforementioned manner, the bag member 200A is made to shrink uniformly when toner is sucked out of the toner storage container 200. Thus, even if part of the bag member 200A is bent, toner is kept from remaining in the bent portion.

Uniform shrinkage of the bag member 200A eliminates the need of attaching such a reinforcing member as the PET sheet, for example, on the surface thereof. This permits further reduction in the weight of the bag member 200, saving of resources and cost cutting.

Tongues 302A, 303A and 304A are provided on the tip ends of the rear flap 302, left flap 303 and right flap 304.

The tongues 302A, 303A and 304A are engaged with the slits 302B, 303B and 304B provided on the respectively corresponding packaging containers 300 when toner is supplied.

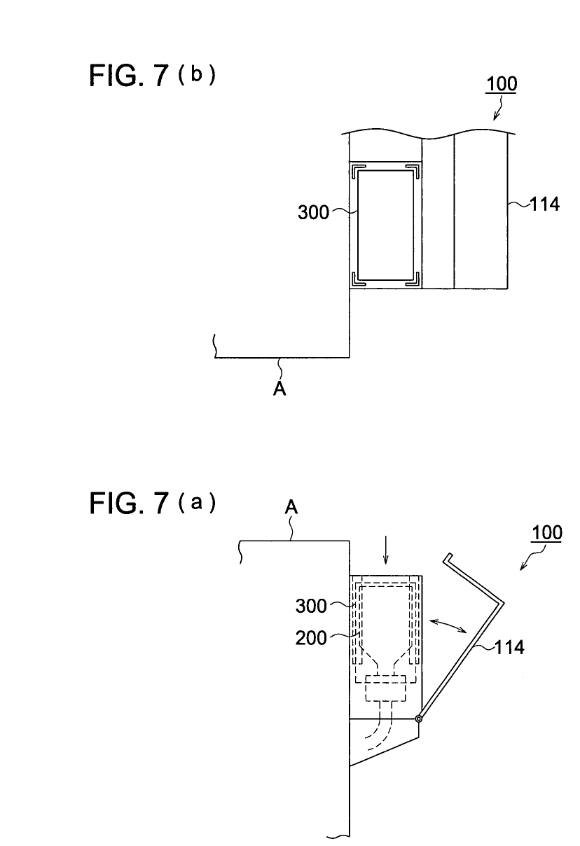

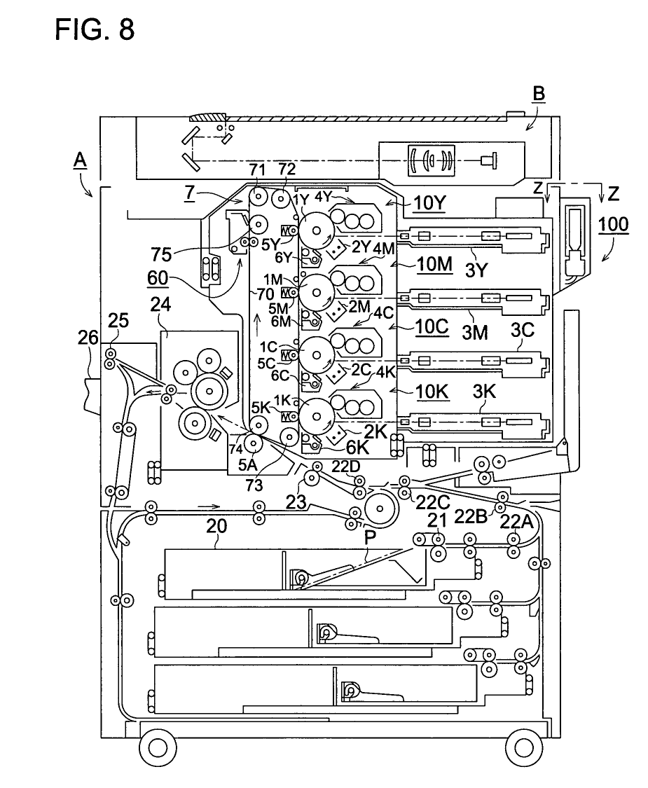

As described above, the tongues 302A, 303A and 304A engaged with the slits 302B, 303B and 304B ensure accurate and smooth mounting (dismounting) of the packaging container 300 on the toner supply section 100 (FIGS. 7 and 8).

In this case, a self-adhesive tape can be used to secure the tongues 302A, 303A and 304A on the side of the packaging container 300.

The following procedure is used to form the side facing the cap member 200B of the toner storage container 200 of the packaging container 300.

The toner storage container 200 filled with toner is inserted into the packaging container 300, and the cap member 200B is inserted into the cap holding hole 301A of the front flap 301. After that, it is bent at the polygonal line portion 301D, and the tongue 301B is engaged with the slit 301C from below.

After that, the left flap 303 and right flap 304 are folded inside. In the final phase, the insertion section 302C of the rear flap 302 is inserted into the packaging container 300.

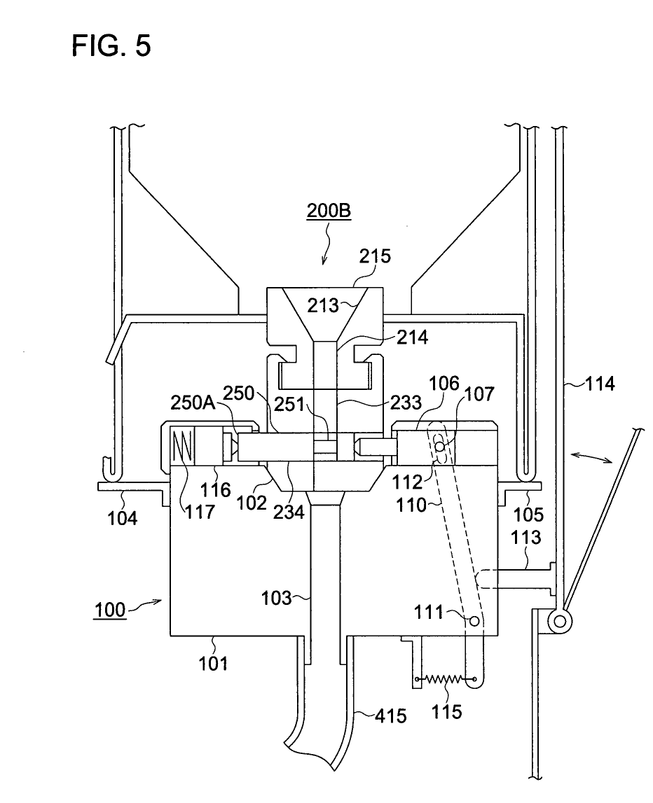

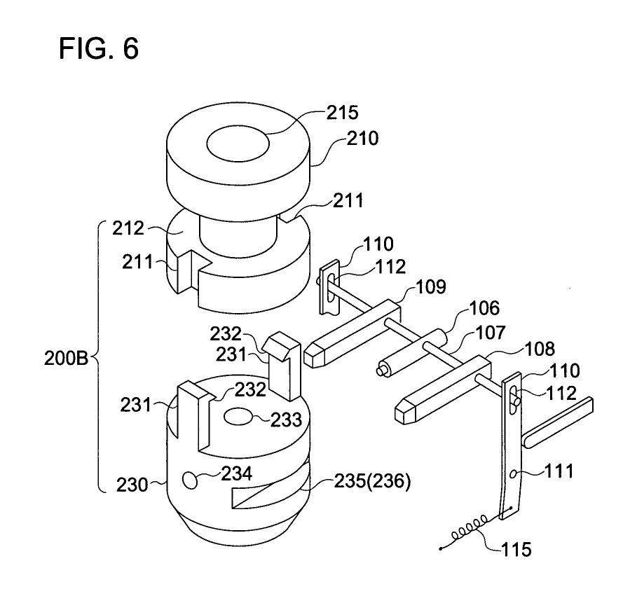

Referring to FIGS. 5 and 6, the following describes the details of the corresponding cap member 200B corresponding to the supply section of the toner storage container 200.

FIG. 5 is a cross sectional view taken along arrow line Z-Z representing the toner supply section 100 in a tandem type color image forming apparatus of FIG. 8. It shows that the cap member 200B of the storage container 200 is fitted to the toner supply section 100 and is mounted thereon.

FIG. 6 is a schematic perspective exploded view of a cap member 200B.

The cap member 200B is equipped with a first cap member 210, second cap member 230 and cylindrical open/close member 250.

Two locking sections 231 are provided on the second cap member 230. The locking section 231 enters the concave receiver 211 provided on the first cap member 210, and the claw 232 of the locking section 231 is engaged with the jaws 212 of the first cap member 210, whereby the first cap member 210 and the second cap member 230 are connected at a predetermined position relative to each other.

The first and second cap members 210 and 230 being connected can be separated by pulling the second cap member 230 downward in FIG. 6.

The center of the first cap member 210 is provided with a first toner outlet 215 made up of a tapering section 213 having an increasingly greater width on the upper portion in FIG. 5 and a cylindrical section 214 connected thereto. The first toner outlet 215 communicates with the second toner outlet 233 arranged on the second cap member 230.

The open/close member 250 can be slid in the hole 234 arranged so as to intersect the second toner outlet 233. Part thereof is provided with a cylindrical toner passage 251 having a smaller diameter than that of the cylindrical section.

Referring to FIGS. 5 and 6, the following describes the details of the toner supply section 100 of the image forming apparatus main body (FIGS. 7 and 8).

In FIG. 5, 101 denotes a toner receiving member for receiving the toner storage container 200 and a packaging container 300 when they are fitted to the toner supply section 100 and are mounted thereon. A tapering section 102 conforming to the tapering section at the tip end of the second cap member 230 is formed approximately at the center.

The reference numeral 103 is a third toner outlet arranged at the center of the toner receiving member 101. It communicates with the second toner outlet 233 of the second cap member 230 through the tapering section 102, and is connected to the tube 415 linked to the section port of the powder pump (to be described later) on the bottom end.

The reference numerals 104 and 105 indicate stoppers for receiving the packaging container 300. They are designed in such a way as to be engaged with the tip end of the packaging container 300 when the tapering section on the tip end of the second cap member 230 is matched to the tapering section 102 of the toner receiving member 101.

The reference numeral 106 indicates a cylindrical pressure member held by the toner receiving member 101 movably in the lateral direction (horizontal direction) of FIG. 5. It is arranged to ensure that the centerline of the pressure member 106 agrees with that of the open/close member 250 when the cap member 200B is fitted with the toner supply section 100.

The reference numeral 107 indicates a drive pin secured on the pressure member 106. It is provided in the direction intersecting the centerline of the pressure member 106 (in the direction perpendicular to the sheet surface of FIG. 5).

As shown in FIGS. 6, 108 and 109 denote a rectangular positioning member secured on the drive pin 107 on both sides of the pressure member 106. It is held by the toner receiving member 101 movably in the lateral direction (horizontal direction) of FIG. 5, and is positioned so as to be fitted into the concave positioning sections 235 and 236 of the second cap member 230 when the cap member 200B is fitted with the toner supply section 100.

The reference numeral 110 is a drive lever arranged movable about the fulcrum 111 on the toner receiving member 101. It has a slot 112, and is engaged with the slot 112 so that the drive pin 107 will be movable.

As shown in FIG. 5, 113 indicates a drive lever pressure member secured to the door 114. When the door 114 has closed, the tip end of the drive lever pressure member 113 is engaged with a position intermediate between the slot 112 of the drive lever 110 and fulcrum 111, so that the pressure member 106 and positioning members 108 and 109 are slid in the leftward direction of FIG. 5.

The aforementioned procedure is followed by the step of the positioning members 108 and 109 being fitted between the positioning sections 235 and 236 of the second cap member 230, whereby the second cap member 230 is accurately fixed in position. Then the pressure member 106 moves the open/close member 250 in the leftward direction to ensure that the toner passage 251 will come to the position indicated in FIG. 5, thereby allowing passage (drop) of toner.

The reference numeral 115 is a drive lever return spring to return the drive lever 110 when the door 114 is opened.

The reference numeral 116 shows a cylindrical return member held by the toner receiving member 101 movably in the lateral direction (horizontal direction) of FIG. 5. The centerline thereof agrees with that of the open/close member 250.

The reference numeral 117 represents a return spring for energizing the return member 116 in the rightward direction of FIG. 5.

As shown in FIG. 5, when the door 114 has closed, the return member 116 is energized by the open/close member 250 and is slid in the leftward direction. When the door 114 has opened, the return member 116 is energized by the return spring 117 and is slid in the rightward direction so as to push back the open/close member 250 until the tip end 250A of the open/close member 250 is matched with the outer peripheral surface of the second cap member 230. To be more specific, the toner passage 251 is moved to the right to prevent passage of toner.

The following describes the operations of each portion when the packaging container 300 of the aforementioned structure is mounted or dismounted from the toner supply section 100.

Before the packaging container 300 (FIGS. 1 and 4) incorporating the storage container 200 is mounted on the toner supply section 100, the operator inserts the members on the side facing the cap member 200B—the tongues 302A, 303A and 304A of the rear flap 302, left flap 303 and right flap 304—into the slits 302B, 303B and 304B so that they will be engaged therewith.

As shown in FIG. 1, the aforementioned procedure releases the side facing the cap member 200B, whereby an opening 300A is formed, and the cap member 200B is exposed.

Referring to FIGS. 7 (a) and (b), the following describes the mounting of the packaging container 300 on the toner supply section 100.

FIG. 7 (a) is a side view close to the toner supply section 100 of FIG. 8. FIG. 7 (b) is a partial plan view of FIG. 7 (a).

The operator opens the door 114. To ensure accurate mounting of the packaging container 300 of FIG. 1 at a predetermined position, the operator inserts it in position along the four guide plates until the tip end of the packaging container 300 contacts the stoppers 104 and 105 (FIG. 5), and the tapering section of the second cap member 230 contacts the tapering section 102 of the toner receiving member 101.

When the operator has completed mounting of the packaging container 300 and has closed the door 114, the drive lever pressure member 113 oscillates in the counterclockwise direction of FIG. 5. This is accompanied by the drive lever 110 oscillating about the fulcrum 111 in the counterclockwise direction.

The oscillation of the drive lever 110 allows the positioning members 108 and 109 to advance through the drive pin 107, and to get into the positioning sections 235 and 236 of the second cap member 230. This arrangement ensures accurate fixing without the second cap member 230 being lifted. At the same time, the pressure member 106 also advances, and the open/close member 250 travels leftward so that the toner passage 251 will be located at the position illustrated in FIG. 5. This procedure allows passage (drop) of toner.

The leftward traveling of the open/close member 250 causes the return member 116 to retract.

After termination of the aforementioned operation, the operator operates the image forming apparatus. Then the toner in the storage container 200 is supplied to the development apparatus of the image forming apparatus, as will be described later.

When the toner in the storage container 200 has been used up, the door 114 is opened by the operator and the packaging container 300 is taken out.

When the door 114 is opened, the return member 116 returns the open/close member 250 to a predetermined position inside the second cap member 230, and the drive lever 110 is oscillated about the fulcrum 111 in the clockwise direction by the action of the drive lever return spring 115.

Oscillation of the drive lever 110 causes the pressure member 106, and the positioning members 108 and 109 to retract. They move away from the second cap member 230 to go back to the predetermined position.

The operator closes the rear flap 302, left flap 303 and right flap 304 of the packaging container 300 having been taken out so that the used cartridge is ready for recovery. As described above, since the used cartridge is equipped with the packaging container 300, the operator is allowed to make the used cartridge ready for recovery quickly and efficiently.

The used cartridge is collected by a vendor and is sent, for example, to the manufacturer's distribution center or production factory. It is also possible to return the used cartridge to the toner charging process for the purpose of recycling the cartridge.

In the toner charging process, the second cap member 230 is removed from the first cap member 210 and toner is recharged. After that, the second cap member 230 is re-mounted on the first cap member 210 for shipment.

Referring to FIG. 8, the following describes the schematic configuration of an example of the embodiment of the image forming apparatus using the aforementioned cartridge:

FIG. 8 is a schematic diagram representing a tandem type color image forming apparatus.

This image forming apparatus is referred to as a tandem type color image forming apparatus. It is made up of a plurality of sets of image forming sections 10Y, 10M, 10C and 10K, an endless belt-like intermediate transfer unit 7, a sheet conveyance section (without reference numeral) and a fixing unit 24. A document image reading apparatus B is mounted on the main unit A of the image forming apparatus.

The image forming section 10Y for forming a yellow image includes a photoreceptor 1Y as an image carrier, a charger 2Y as an image forming apparatus arranged around the photoreceptor 1Y, an exposure unit 3Y, a development apparatus 4Y, a primary transfer roller 5Y as a primary transfer unit also serving as an image forming apparatus, and a cleaning section 6Y.

The image forming sections 10M for forming a magenta image contains a photoreceptor 1M, a charger 2M arranged around the photoreceptor 1M, an exposure unit 3M, a development apparatus 4M, a primary transfer roller 5M, and a cleaning section 6M.

The image forming sections 10C for forming a cyan image includes a photoreceptor 1C, a charger 2C arranged around the photoreceptor 1C, an exposure unit 3C, a development apparatus 4C, a primary transfer roller 5C and a cleaning section 6C.

The image forming sections 10K for forming a black image contains a photoreceptor 1K, a charger 2K arranged around the photoreceptor 1K, an exposure unit 3K, a development apparatus 4K, primary transfer roller 5K, and a cleaning section 6K.

The development apparatuses 4Y, 4M, 4C and 4K respectively incorporate the two-component developers (one-component developers also acceptable) made up of the toner of yellow (Y), magenta (M), cyan (C) and black (K) charged to have the same polarity as that of the photoreceptors 1Y, 1M, 1C and 1K. They are equipped with, for example, development rollers 4Y1, 4M1, 4C1 and 4K1 as developer carriers formed of cylindrical non-magnetic stainless or aluminum material having a thickness of 0.5 mm through 1 mm and an outer diameter of 15 mm through 25 mm.

The development rollers 4Y1, 4M1, 4C1 and 4K1 are held respectively in a noncontact position by a hitting roller (not illustrated) with a predetermined gap (e.g., 100 μm through 1000 μm) with respect to the photoreceptors 1Y, 1M, 1C and 1K. At a position facing the photoreceptor, these rollers are rotated in the same direction as that of the photoreceptors 1Y, 1M, 1C and 1K.

In the phase of development, when the direct voltage having the same polarity as that of the toner, or the development bias voltage obtained by superimposing the alternating voltage on the direct voltage is applied to the development rollers 4Y1, 4M1, 4C1 and 4K1, contactless reversal development is carried out with respect to the electrostatic latent image on the photoreceptors 1Y, 1M, 1C and 1K.

The intermediate transfer unit 7 includes a plurality of rollers 71, 72, 73, 74 and 75, and a semi-conductive endless belt-like intermediate transfer unit 70 as an image carrier.

The intermediate transfer unit 70 is provided in the form circumscribing the drive roller 73 connected with a drive motor (not illustrated), support rollers 71 and 72, secondary transfer backup roller 74, and backup roller 75, and is arranged in such a way that the intermediate transfer unit 70 will rotate in the clockwise direction of FIG. 8. The primary transfer rollers 5Y, 5M, 5C and 5K of respective colors are arranged at a position facing the photoreceptors 1Y, 1M, 1C and 1K through the intermediate transfer unit 70.

The direct voltage having a polarity reverse to that of toner is applied to the primary transfer rollers 5Y, 5M, 5C and 5K, and a transfer field is formed in the transfer area. Thus, the toner images of respective colors formed on the photoreceptors 1Y, 1M, 1C and 1K are primarily transferred on the intermediate transfer unit 70.

A secondary transfer roller 5A as an image formation section is arranged at a position facing the secondary transfer backup roller 74 through the intermediate transfer unit 70.

The direct voltage having a polarity reverse to that of toner is applied to the secondary transfer roller 5A, and a transfer field is formed in the transfer area. Thus, the superimposed toner images carried on the intermediate transfer unit 70 are secondarily transferred onto the surface of the transfer material (sheet) P.

The sheet P is fed from the sheet feed cassette 20 by the sheet feed section 21. It is conveyed to the secondary transfer position through a plurality of intermediate rollers 22A, 22B, 22C and 22D, and the registration roller 23, whereby the color images are transferred in one operation.

The sheet P to which the color image has been transferred is subjected to the process of fixing by the fixing unit 24. Being sandwiched by the sheet ejection roller 25, the sheet P is placed on the ejection tray 26.

A cleaning section 60 for removing the toner remaining on the intermediate transfer unit 70 is provided on the downstream side of the secondary transfer position, as viewed from the rotational direction of the intermediate transfer unit 70.

The following describes the details of the development apparatus 4Y, 4M, 4C and 4K:

Referring to FIG. 8, the following describes the image formation process.

When image recording has started, the drive motor (not illustrated) of the photoreceptor 1Y starts to operate, and the photoreceptor 1Y of the yellow (Y) image forming section 10Y is rotated in the arrow-marked counterclockwise direction of FIG. 8. At the same time, potential is applied to the photoreceptor 1Y by the charging operation of the charger 2Y.

After potential has been applied to the photoreceptor 1Y, writing of the image by the exposure unit 3Y is started in response to the first color signal, namely, the electrical signal corresponding to the Y image data. The electrostatic latent image corresponding to the Y image of the document is formed on the surface of the photoreceptor 1Y.

The electrostatic latent image is subjected to reversal development in a contact or contactless state by the development roller 4Y1, and a yellow (Y) toner image is formed on the photoreceptor 1Y in response to the rotation of the photoreceptor 1Y.

The Y toner image formed on the photoreceptor 1Y by the aforementioned image formation process is transferred onto the intermediate transfer unit 70 by the primary transfer roller 5Y.

After that, synchronized with the Y toner image on the intermediate transfer unit 70, magenta (M), cyan (C) and black (K) toner images are sequentially formed by superimposition, whereby a color toner image is formed on the intermediate transfer unit 70.

The transfer toner remaining on the surfaces of the photoreceptors 1Y, 1M, 1C and 1K subsequent to transfer operation is removed by the cleaning sections 6Y, 6M, 6C and 6K.

Synchronously with the formation of a color toner image on the intermediate transfer unit 70, the sheets P conveyed from the sheet feed cassette 20 after being separated in each sheet are each conveyed through the registration roller 23, and color toner images on the intermediate transfer unit 70 are transferred in one operation by the secondary transfer roller 5A.

The sheets P after the process of transfer are electrically discharged by a separation device (not illustrated) and are conveyed to the fixing unit 24. After the toner image has been fixed, the sheets are ejected into the ejection tray 26 by the sheet ejection roller 25.

The transfer toner remaining on the surface of the intermediate transfer unit 70 subsequent to transfer operation is removed by the cleaning section 60.

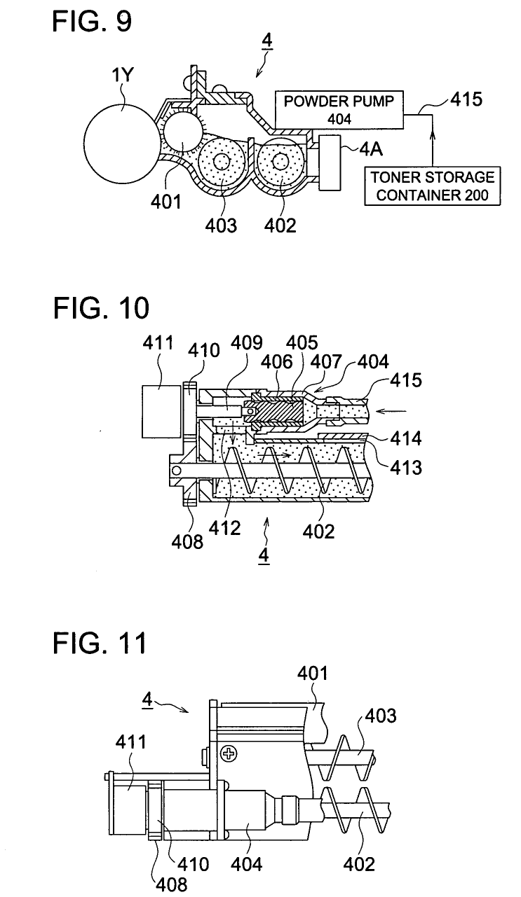

Referring to FIGS. 9 through 12, the following describes the development apparatuses 4Y, 4M, 4C and 4K. Since these apparatuses have basically the same structure, the development apparatus 4Y will be referred to in the following description. In this case, the reference symbol Y representing the toner color will be omitted.

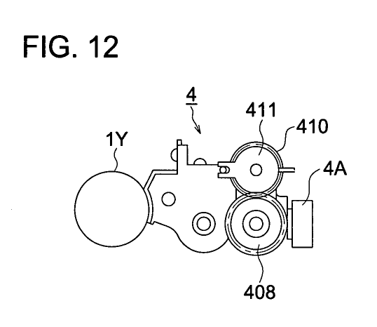

FIG. 9 is a schematic diagram representing the internal structure of a development apparatus 4 and the toner supply section. FIG. 10 is a partial plan view of the end of the development apparatus 4 of FIG. 9. FIG. 11 is a partial plan view of the development apparatus 4 of FIG. 9. FIG. 12 is a side view of the development apparatus 4 of FIG. 9.

The development apparatus 4 is provided with a development sleeve 401 facing the photoreceptor 1Y, a first stirring screw 402, and a second stirring screw 403. The developer inside the development apparatus 4 is circulated in such a way as to be conveyed from left to right by the first stirring screw 402, and from right to left by the second stirring screw 403. In the process of circulation, the electrostatic latent image formed on the photoreceptor 1Y is developed at some midpoint of the conveyance path by the developer shifted onto the development sleeve 401. The reference numeral 4A denotes a toner density sensor.

The top of this development apparatus 4 is provided with a powder pump 404. A suction type uniaxial eccentric powder pump is used as the powder pump 404. This powder pump 404 includes a rotor 405 formed in an eccentric screw using such a rigid material as metal; a stator 406 as an elastic body such as a rubber which is formed in a double-threaded screw inside and is mounted by fixing; and a holder 407 for wrapping them and forming a powder conveyance path, the holder 407 being made of resins and others.

In the present embodiment, a gear 408 which is connected integrally with the first stirring screw 402 and is further connected by drive with the drive apparatus (not illustrated) is meshed with a gear 410 integrally connected with the drive shaft 409 further connected integrally with the rotor 405 by a pin joint. The gear 410 includes an electromagnetic clutch 411 as an interrupting device for interrupting rotation and drive by the gear 408.

However, the first and second stirring screws 402 and 403 are normally driven and rotated at the time of image formation. Accordingly, if the powder pump 404 is connected integrally with the first stirring screw 402 for drive, toner will be supplied when the first stirring screw 402 is driven. This will prevent application to the development apparatus that supplies toner based on the developer density control.

To solve this problem, transmission of drive to the powder pump 404 is placed under the control of the electromagnetic clutch 411. This arrangement permits application to the development apparatus wherein control is provided to ensure that the developer density inside the development apparatus 4 is kept constant.

In the present embodiment, a permeability detector 4A is provided in the development apparatus 4. This detector 4A is used to detect the amount of toner in the development apparatus 4 changes in the blending ratio of the carrier. If an insufficient amount of toner has been detected, the electromagnetic clutch 411 turns on to operate the powder pump 404, whereby toner is supplied. When the density of the developer in the development apparatus 4 has reached a predetermined level, the electromagnetic clutch 411 turns off. Then the operation of the powder pump 404 is disabled even if the first stirring screw 402 is being driven and rotated. Accordingly, no toner is supplied. In this case, an adequate method can be applied for the development apparatus 4. For example, it is possible to use the method of detecting the reflection density of the toner image formed on the photoreceptor, thereby controlling the amount of toner to be supplied.

In the powder pump 404, a great self-sucking force is produced by the rotation of the rotor 405 so that toner can be sucked from the toner storage container 200 to be described later.

The toner having been sucked is transported into the development apparatus 4 by the supply inlet 412 (FIG. 10) formed between the powder pump 404 and first stirring screw 402. When the two-component development method is used, the toner supplied in the process of transport is stirred and blended with the developer inside the development apparatus 4, whereby uniform density and adequate amount of electrical charge are ensured.

The development apparatus is provided with a vent 413 (FIG. 10) and a filter 414 for covering the vent 413. This arrangement removes only the air from the development apparatus 4, and reduces an increase in pressure of the apparatus in the phase of development, thereby stabilizing toner supply and preventing the toner of the development apparatus from being scattered.

The tube 415 connected to the suction port of the powder pump 404 is a flexible tube having a diameter of 4 mm through 10 mm for example. It is very effective to use the tube made of a rubber material (e.g., polyurethane, nitrile, EPDM and silicon) characterized by excellent resistance to toner.

As described above, the present embodiment provides the following advantages:

(1) While toner or ink are supplied, the cartridge together with packaging container is mounted on the image forming apparatus. This arrangement eliminates the need of securing a space for temporary storage of the packaging container or providing management to prevent the packaging container from being lost. Thus, this cartridge minimizes the user's load.

(2) There is no risk of the packaging container being lost, and reliable recovery of the user cartridge including the packaging container is ensured. This technique provides a cartridge friendly to earth environment without any waste of packaging container.

(3) When the cartridge is mounted, there is no need of taking the storage container for storing toner or ink from the packaging container or packing the used storage container in the packaging container. This technique provides a cartridge characterized by enhanced usability for users.

(4) If the bag member of the storage container is secured to the inner surface of the packaging container, uniform shrinkage of the bag member is ensured when the image forming material is sucked from the storage container. This arrangement prevents part of the bag member from being bent, and eliminates the possibility of the image forming material remaining at that position.

(5) If the bag member of the storage container is secured to the internal surface of the packaging container, uniform shrinkage of the bag member is ensured. For example, there is no need of attaching a reinforcing member such as a PET sheet onto the surface thereof, which saves the resources and cuts down the cost.

(6) Recharging of the image forming material in the charging process can be made when a cap member is made up of two cap members that can be separated.

(7) The storage container accommodated in the packaging container can be mounted on the image forming apparatus. Thus, the heat insulation effect of the packaging container reduces the adverse effect of heat generation inside the image forming apparatus upon the image forming material in the storage container. This arrangement is preferably applied to the toner subjected to low-temperature fixing, for example.

The present embodiment assumes that all the sides of the toner storage container facing the cap member are opened. However, it is also possible to make such arrangements that some of these sides are opened.

To discharge toner from the cap member or to block the toner, it is possible to use another structure than that of the present embodiment. For example, the structures disclosed in the Japanese patent laid-open publication No. 2001-324863 or Japanese patent laid-open publication No. 2005-331622 can be utilized. Further, toner can be discharged or blocked by a motor, electromagnetic solenoid or others.

The present embodiment has been described with reference to a cartridge for the toner used in the formation of an image using electrophotographic process. The present invention is also applicable to the cartridge for the ink used to form an image according to the ink jetting process, for example.

What is claimed is:

1. A cartridge detachably mountable to a main body of an image forming apparatus comprising:
a storage container for storing an image forming material having a supply section which supplies the image forming material when engaged with a main body of the image forming apparatus; and
a packaging container for packaging the storage container, the packaging container can expose the supply section of the storage container through an opening provided on the packaging container, while packaging the storage container,
wherein the cartridge is loaded on the main body of the image forming apparatus in such a state that the storage container is packaged by the packaging container.

2. The cartridge of claim 1, wherein the storage container includes a flexible bag-like container.

3. The cartridge of claim 1, wherein the storage container is integrated with the packaging container by adhesion or built-in.

4. The cartridge of claim 2, wherein the storage container is integrated with the packaging container by adhesion or built-in.

5. The cartridge of claim 1, wherein the image forming material is a toner for use in an electrophotographic image formation.

6. The cartridge of claim 2, wherein the image forming material is a toner for use in an electrophotographic image formation.

7. The cartridge of claim 3, wherein the image forming material is a toner for use in an electrophotographic image formation.

8. The cartridge of claim 1, wherein one surface of the packaging container is provided with treatment that allows printing.

9. The cartridge of claim 8, wherein distribution information of the cartridge is printed on the surface of the packaging container.
